(19) United States
(12) Patent Application Publication
(10) Pub. No.: US 2010/0293145 A1
(43) Pub. Date: Nov. 18, 2010

(54) Method of Selective Replication in a Storage Area Network

(75) Inventors: Abhik Das, Bangalore (IN); Rajesh Anantha Krishnaiyer, Bangalore (IN)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/497,433

(22) Filed: Jul. 2, 2009

(30) Foreign Application Priority Data
May 15, 2009 (IN) 1133/CHE/2009

(51) Int. Cl. G06F 17/30; G06F 12/02

(52) U.S. Cl. 707/640; 707/813; 707/823; 707/805; 707/673

(57) ABSTRACT

A method includes identifying with a server a first range of data blocks in a storage device array corresponding to data files selected for replication, the first range of data blocks being managed by a source host device; mapping the first range of data blocks to a second range of data blocks in the storage device array managed by the destination host device; copying the data blocks from the first range that contain the data files selected for replication to the corresponding data blocks in the second range; deleting files in the copied data blocks of the second range that have not been selected for replication; and condensing the second range of data blocks.

### RELATED APPLICATIONS

The present application claims priority under 35 U.S.C. §119(a)-(d) or (f) of, previously-filed India patent application No. 1133/CHE/2009, entitled “Method of Selective Replication in a Storage Area Network,” filed May 15, 2009, which application is incorporated herein by reference in its entirety.

### BACKGROUND

A storage area network is a networking architecture used to connect storage devices to servers so that the storage devices appear to the server as local volumes attached to the server operating system. Storage area networks are typically used by large corporations or entities. Use of a storage area network simplifies storage administration and can provide greater reliability.

One operation commonly used in storage area network administration is a replication. A replication is a process in which data is transferred between redundant storage devices to ensure data availability while maintaining consistency. A replication creates a replica which is a volume identical to the volume being replicated. The main purpose for creating replicas is to facilitate backup and archiving operations. The use of replication can increase reliability, fault-tolerance, and data availability.

When using a storage area network, because data is spread across storage devices spread out over different geographic localities, replications can place a heavy load on system processing resources.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram depicting an illustrative storage area network, according to one exemplary embodiment of the principles described herein.

FIG. 2 is a flow diagram depicting an illustrative method for performing a selective replication in a storage area network, according to one exemplary embodiment of the principles described herein.

FIG. 3 is a diagram depicting an illustrative configuration process in a method for performing a selective replication in a storage area network, according to one exemplary embodiment of the principles described herein.

FIG. 4 is a table depicting an illustrative set of policies for a performing a selective replication in a storage area network, according to one exemplary embodiment of the principles described herein.

FIG. 5 is a flow diagram depicting an illustrative query process in a method for performing a selective replication in a storage area network, according to one exemplary embodiment of the principles described herein.

FIG. 6 is a diagram of an illustrative mapping process in a method for performing a selective replication in a storage area network, according to one exemplary embodiment of the principles described herein.

FIG. 7 is a flow diagram depicting an illustrative mapping process in a method for performing a selective replication in a storage area network, according to one exemplary embodiment of the principles described herein.

FIG. 8 is a flow diagram of an illustrative cleanup process in a method for performing a selective replication in a storage area network, according to one exemplary embodiment of principles described herein.

Throughout the drawings, identical reference numbers designate similar, but not necessarily identical, elements.

### DETAILED DESCRIPTION

As described above, backing up or archiving a volume employed by storage area networks can utilize substantial time and system processing resources. The transferring of data to a large disk storage device may take a significant amount of time as large storage devices may sometimes have higher read and write latencies. Furthermore, volumes in use on a storage area network are frequently being read and written to by multiple users. If writes occur to a volume during backup, it may be possible that the backup data or the data stored on the volume can become inconsistent, corrupted or lost. Because it is often not acceptable to disallow writes for the time in which a time consuming backup is being performed, a replica is created and data can be backed up from the replica, allowing the original volume to continue its normal operations.

The replication process can often utilize valuable system resources. It is often the case that a volume being replicated contains many files which are less critical and do not need to be backed up as frequently as more critical files. Time and system processing resources may be wasted to transfer data that either does not change very often, or is not important enough to be archived regularly if at all.

The present specification describes methods, systems, and computer program products for creating a selective replica based on selected files only as determined by a system administrator. Consequently, the methods, systems, and computer program products described herein do not rely on a full replica of a volume on a storage area network to create a backup of the significant files stored in the volume.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles described in the present specification may be implemented entirely in hardware, as a combination of hardware and software, and/or as a computer program product having functional computer readable code stored on a computer readable medium.

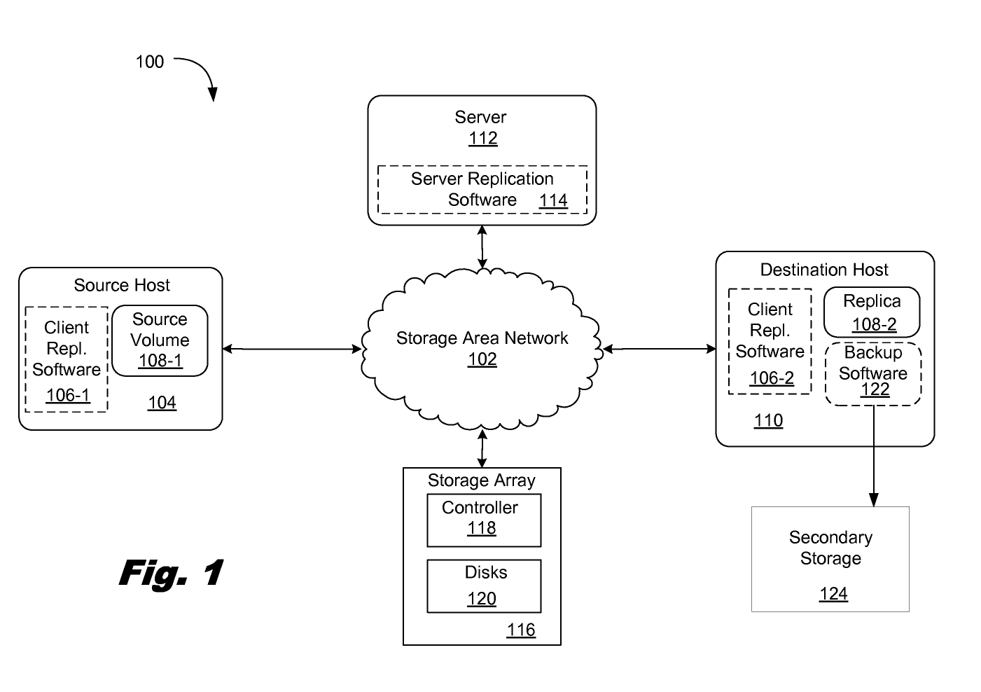

FIG. 1 is a diagram of an illustrative storage system (100) wherein replication may occur. The illustrative storage system (100) includes a storage area network (102) interconnecting various devices (104, 110, 112, 116). A client replication software component (106-1, 106-2) is installed on various host devices (104, 110) connected to the storage area network (102). Each of the host devices may include at least a processor and one or more local data storage device. The local data storage devices of the host devices (104, 110) may be configured to store at least a client replication software component (106-1, 106-2). The client replication software may be executed by the processor of each host device (104, 110), and is responsible for providing host specific information to the server replication software component (114). The server replication software component (114) is installed on a server (112) that is also connected to the storage area network (102) such that a system administrator may manage the host devices (104, 110) and other devices connected to the storage area network (102).

A storage array (116) may also be connected to the storage area network (102). The storage array (116) may include several volumes spread across multiple disk drives (120) which are allocated for use by host devices (104, 110). The storage array (116) may be controlled by a hardware array controller (118) configured to interface with the network (102) and perform space management operations on the disks (120) in the storage array (116). The array controller (118) includes embedded firmware to achieve its desired functionality.

In one example of volume replication for the purpose of backing up critical data, the source volume (108-1) used by a source host (104) is copied to a destination or replica volume (108-2) on a destination host (110). The source volume (108-1) may be implemented on a storage device local to the source host (104). The source volume may consist of drive space allocated from the storage array (116) and accessible to the source host (104) over the network (102). A source host (104) may have any number of source volumes (108-1) as may best suit a particular application of the principles described herein.

The replication may be processed by a collaborative effort between the server replication software component (114) and the client replication software components (106-1, 106-2) installed on both the source host (104) and the destination host (110). Once a replica has been made, the data from the replica may be archived or backed up onto any type of secondary or backup storage device (124). The backup or archival operations may be processed by a backup or archival piece of software (122).

The selective replication method embodying principles described herein is not limited to use on a network architecture setup precisely in the manner described above. Any setting for creating a replica for any purpose may suffice for an environment in which the selective replication method may be used.

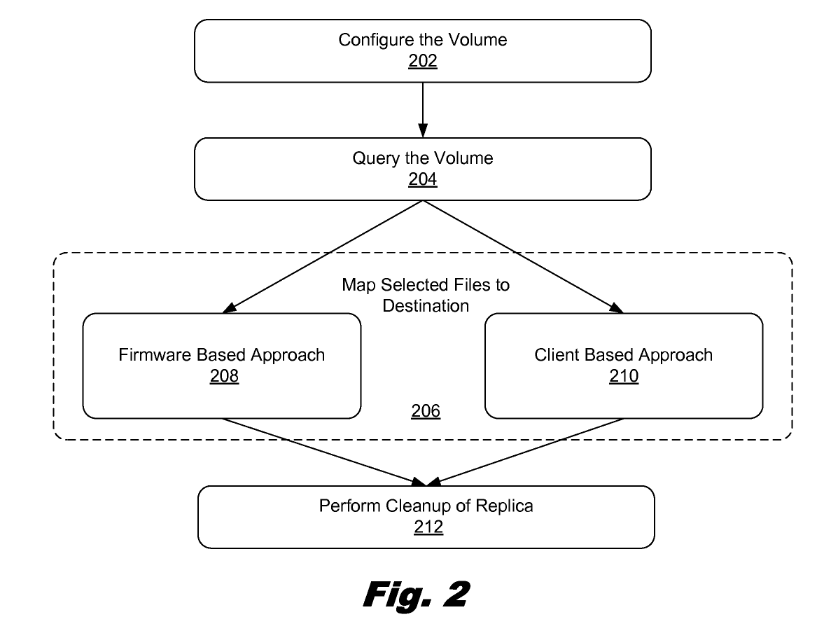

FIG. 2 is a flow diagram of an illustrative method (200) for performing a selective replication of a volume in a storage network. The present method (200) of selective replication creates a replica containing only files from the volume that are selected by a user or system administrator. The replication is accomplished through four primary steps.

The first step is that of configuring (step 202) the volume for backup. During this step, a user or system administrator selects files, directories, and/or file types in the volume are critical and will need to be backed up on a regular basis. The user or system administrator may also assign a time interval between successive replication jobs for different files, directories, and/or file types.

The next step is the query step (204) wherein the client software (106-1, FIG. 1) of the source host (104, FIG. 1) queries the volume to be backed up to determine the range of blocks on a source volume which contain the data and metadata for the files which have been selected as critical for backup.

The third step in the replication process (200) is that of mapping (step 206) data to be replicated from the range of blocks managed by the source volume to a range of blocks managed by the destination host (110, FIG. 1). There are several embodiments whereby the mapping may be facilitated. For example, in certain embodiments a firmware-based approach (208) may be used wherein the firmware embedded in a storage array controller (118, FIG. 1) maps the block information to specific physical blocks in the storage array (116, FIG. 1) under the control of the destination host (110, FIG. 1). A replica may then be created having only the blocks required to store the files that have been selected by a user or system administrator.

According to one example embodiment the mapping may involve a destination host (110, FIG. 1) based approach (210) in which a server (112, FIG. 1) reports to the destination host the location of the blocks containing selected files stored on the source host. The destination client software (106-2, FIG. 1) then maps all of the blocks to a range of blocks in the storage array (116, FIG. 1) managed by the destination host (110, FIG. 1). Some blocks may contain non selected files which may then be deleted.

A final step in the illustrative replication (200) is that of performing (step 212) a cleanup of the replica. If the embodiment using the firmware approach is used, the client software on the destination host will perform consistency checks and correct any file system inconsistencies. Regardless of which mapping method is used, the replica cleanup may include reduced the replica in size by de-allocating the storage blocks which had contained data relating to files which have not been selected for replication by the system administrator.

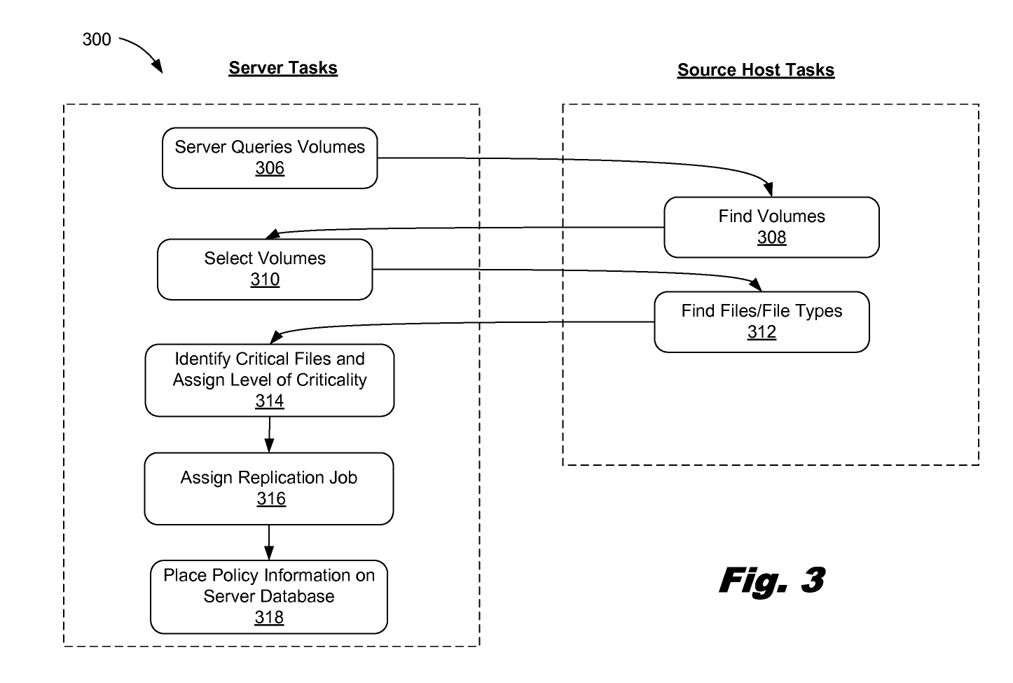

FIG. 3 is an illustrative diagram depicting an illustrative configuration process (300) according to the configuration step (step 202, FIG. 2) of the method (200, FIG. 2) for performing a selective replication described with respect to FIG. 2. In FIG. 3, tasks are divided into tasks performed by the server replication software component installed on a management appliance and the tasks performed by a client replication software component installed on one or more source hosts.

The server (112, FIG. 1) may begin by querying (step 306) a source host (104, FIG. 1) on the network (102, FIG. 1) and requests information on all of the volumes managed by the source host (104, FIG. 1). Next, the client software queries the operating system associated with the source host (104, FIG. 1) to find (step 308) information about the volumes managed by the source host (104, FIG. 1) and responds to the server's query with the requested information. A user or system administrator may then select (step 310) which volumes to setup selective replication via a user interface of the server. The selection is forwarded from the server (112, FIG. 1) to the source host (104, FIG. 1) with a request that the source host client software (106-1) report specific file-system information on the volume or volumes which have been selected by the user or system administrator. The client then queries the operating system running the host to find (step 312) the file-system specific information requested by the server (112, FIG. 1) and reports the information back to the server (112, FIG. 1), where it may be viewed by the user or system administrator.

After file specific information on selected volume (108-1, FIG. 1) or volumes has been reported to the user or system administrator, the user may then identify (314) certain files, directories, and/or file types that are critical to replication and assign them to a level of criticality and/or accompanying schedule for replication. The user or system administrator may then assign (step 316) a replication job to the files, directories, or file types which have been selected. A replication job is a collection of certain tasks that creates a replica of a host volume by issuing a sequence of commands to the storage array controller (118, FIG. 1). Corresponding policy information may then be placed (step 318) on a server database to persist these replication policies as determined by the user or system administrator.

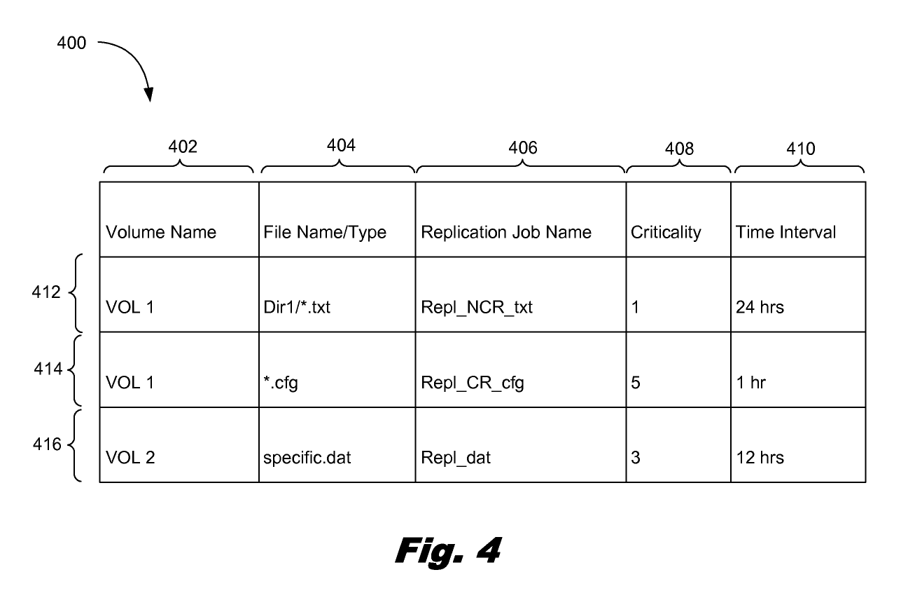

FIG. 4 is an illustrative table depicting an exemplary set (400) of policies for a performing a selective replication. As mentioned above, during the configuration step, the user or system administrator may select which files, directories or file types may be selected and assigned replication jobs. The table in the figure contains some but not all of the possible assignments which can be made to a selective replication job and placed in a server database.

In the present example, the first column (402) displays the name of the volume (108-1, FIG. 1) containing files which are being assigned a replication job. The next column (404) selects the exact files which will be assigned a specific replications job. The third column (406) is the name of the replication job being assigned. The fourth column (408) is the level of criticality being assigned to the replication job. For example, in certain embodiments the level of criticality may be a numerical value, where a higher numerical value is interpreted as a higher level of criticality. The level of criticality is not limited to a set number. Any embodiment of the selective replication method may contain any number of different criticality levels. The fifth column (410) is the time interval in between successive replication jobs. Generally, the more critical the job is, the more often it will be performed.

In the present example, the first row (412) is an example of a selective replication job which could be assigned by a user or system administrator. In this example, the replication job is being performed on a volume (VOL 1). The job has been set to replicate the text files in a specific directory. An exemplary name for this job could be “Repl_NCR_txt.”

The second row (414) is another example of a selective replication job which could be assigned by a user or system administrator. In this example the replication is also being performed on VOL 1. For this job, the replication is performed on all the cfg (configuration) files on the volume. An exemplary name for this job could be “Repl_CR_cfg.” Because it is often considered important to frequently update configuration files, a higher level of criticality may be assigned to configuration files. For example, configuration files may be replicated once every hour.

The third row (416) is a third example of a replication job which could be assigned by a user or system administrator. For this job, the replication is performed on all the dat (data) files on VOL 2. An exemplary name for this job could be “Repl_SC_dat.” In this example, the data files on VOL 2 are considered to be semi-critical, thus they have been assigned a midrange level of criticality of 3. The replication is thus performed every 12 hours.

The types of jobs available for a selective replication method embodying principles described herein are not limited to the examples mentioned above.

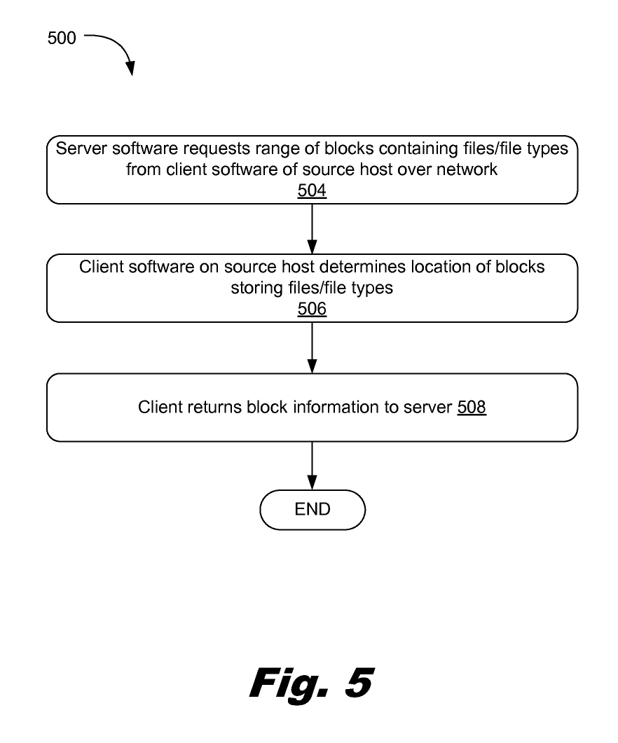

FIG. 5 is an illustrative flow diagram depicting one exemplary process (500) for the query step (step 204) used by the method (200, FIG. 2) in performing a selective replication. As mentioned above, the query step involves the client software (106-1, FIG. 1) of the source host (104, FIG. 1) reporting to the server (112, FIG. 1) the location of the storage blocks storing the files or file types to be replicated. Storage is typically divided into smaller units referred to as blocks. Data is transferred between different volumes in blocks. Depending on the system, the size of blocks may vary.

When a replication job begins, the server replication software (114, FIG. 1) of a server (112, FIG. 1) may query the client replication software (106-1, FIG. 1) embodied in a source host (104, FIG. 1) through a storage area network (102, FIG. 1) to request (step 504) the range of blocks which are holding the files to be replicated. This range of blocks may typically be stored in a portion of the storage array (116, FIG. 1) that is associated with and managed by the source host (104, FIG. 1). In response to the query, the client replication software (106-1, FIG. 1) of the source host (104, FIG. 1) may query the operating system of the source host (104, FIG. 1) to determine (step 506) the exact location in the storage array (116, FIG. 1) of the range of blocks holding the files to be replicated. The client replication software (106-1, FIG. 1) of the source host (104, FIG. 1) may then report (step 508) the location and range of those blocks back to the server replication software (114, FIG. 1). After the initial query process (500), execution may begin of the mapping step (step 206, FIG. 2) in the selective replication method (200, FIG. 2).

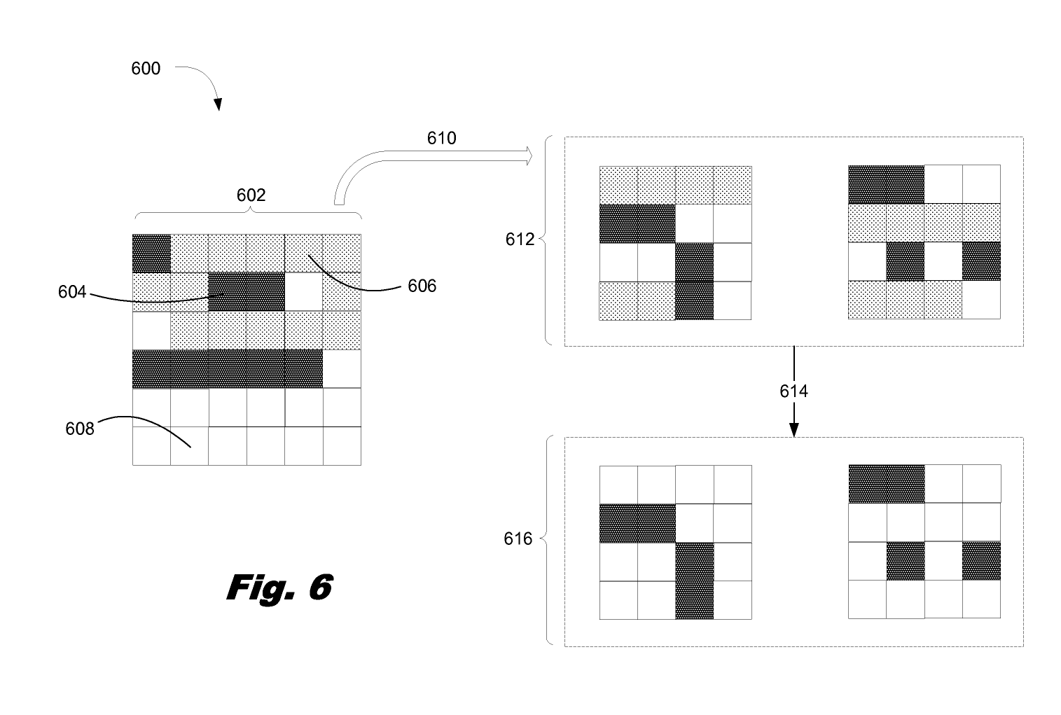

FIG. 6 is a diagram depicting an illustrative storage array controller (118) based mapping process (600) that may be used in a method (200, FIG. 2) of performing a selective replication. In certain embodiments, the server (112, FIG. 1) may instruct the storage array controller (118) directly to perform the mapping process. The server (112, FIG. 1) may also instruct the destination host (110, FIG. 1) to perform the mapping. When using the storage array controller (118, FIG. 1) approach, the firmware embedded in the storage array controller (118, FIG. 1) maps the range of blocks containing the files selected for replication associated with the source volume (108-1) to a second range of blocks in the storage array (116, FIG. 1) that is managed by the destination host (110) and associated with the replica volume (108-2). The firmware then creates a replica containing only the blocks with the files which have been selected for replication.

The blocks (602) on the left of FIG. 6 represents the range of blocks in the storage array (116) corresponding to the source volume (108-1) managed by the source host (104) that contain files which have been selected for replication in the present example. The darker blocks (604) represent blocks containing data related to the files which have been selected for replication. The lighter blocks (606) represent blocks containing additional files which have not been selected for replication. The non-shaded blocks (608) represent unused blocks in the source volume.

In certain embodiments, the firmware embedded in the storage array controller (118) may be responsible for mapping (610) the range of blocks (602) on the source volume (108-1, FIG. 1) to the range of blocks (612) in the storage array (116-1, FIG. 1) corresponding to the replica volume (108-2, FIG. 1). All the blocks within the identified range of blocks containing all files which have been selected for replication may be mapped to the corresponding range of blocks in the storage array (116-1, FIG. 1) corresponding to the replica volume (108-2, FIG. 1). Once this has occurred, the actual replication (614) may take place. A replica (616) may then be created by copying only the blocks containing data from files which have been selected for replication. The blocks in the selected portion of the storage array (116-1, FIG. 1) that have been allocated to unreplicated portions of the source volume will not be written to at this time, but may be reserved for other replication processes that may replicate the unreplicated blocks (606) of the source volume (108-1, FIG. 1) at a later time. Furthermore, to maintain file consistency, the block may remain in the same offset position. It will be apparent to those skilled in the relevant art that this is done to satisfy the methods of which storage is managed.

The process of mapping blocks as depicted in FIG. 6 is shown on a much smaller scale for illustrative purposes. Typical replication processes may involve mapping thousands or millions of blocks.

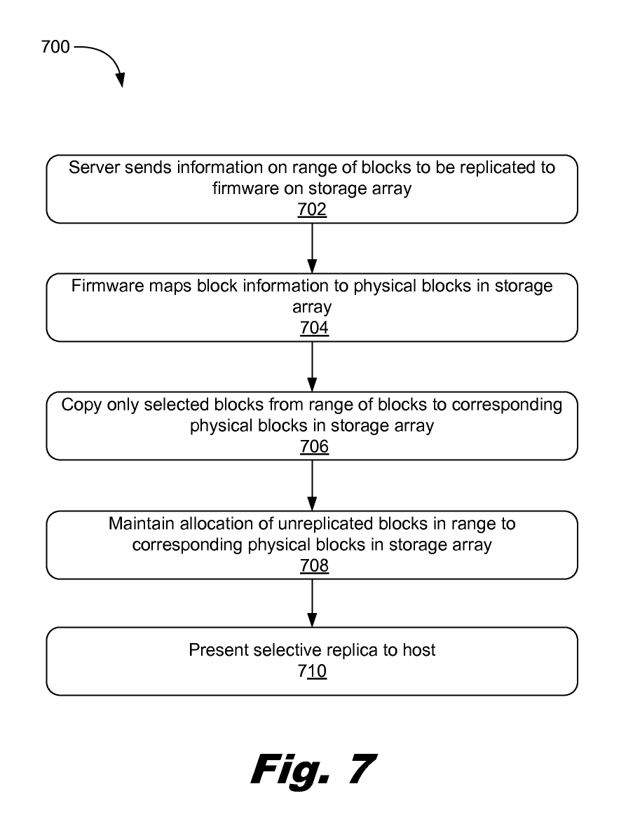

FIG. 7 is a flow diagram depicting an illustrative storage array controller (118, FIG. 1) based mapping process (700). The mapping process (700) may be used by the method (200, FIG. 2) for performing a selective replication consistent with the principles described in FIG. 6. A server (112, FIG. 1) sends (step 702) information about the range of blocks in the storage array (116, FIG. 1) corresponding to the source volume (108-1) managed by the source host (104, FIG. 1) that contains files which have been selected for replication to the firmware on the storage array (116, FIG. 1). The firmware may then map (step 704) each block in that range of blocks to a block in a corresponding range of blocks in the replica volume (108-2) controlled by the destination host (110). The blocks in the selected range which contain data relating to files which have been selected are copied (step 706) to create the replica. Unreplicated blocks in the selected range are still allocated to destination range of blocks in the storage array to maintain (step 708) continuity in data offset positions. The replica may then be presented to a destination host (step 710). The destination host may then perform any relevant task with the replica. As mentioned above, the most common use of a replica is for backup or archiving to a secondary storage device.

In the case that the client-based approach to mapping (step 206, FIG. 2) is used in place of the storage array controller (118) approach illustrated in FIGS. 6-7, a server (112, FIG. 1) may report to the destination client software (106-2, FIG. 1) of a destination host (110, FIG. 1) the range of blocks which contain data selected for replication on the source volume. According to this approach, all blocks may be replicated and unwanted blocks removed in the cleanup process. The cleanup process may include deletion of unwanted files by destination client software (106-2, FIG. 1).

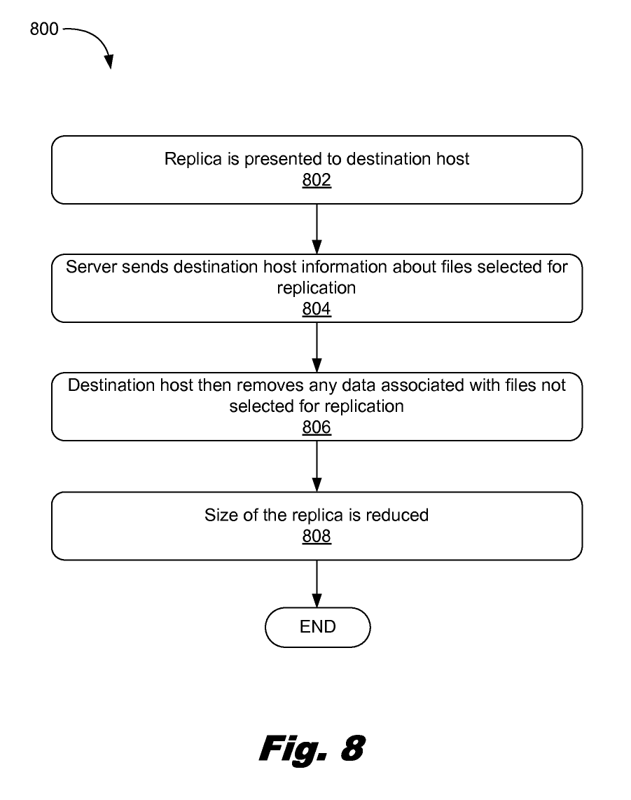

FIG. 8 is a flow chart depicting an illustrative cleanup process (800) that may be used in a method (200, FIG. 2) for performing selective replication consistent with the principles described herein. The illustrative cleanup process (800) may be performed by the storage array controller (118, FIG. 1) under the direction of the destination host (110, FIG. 1). In certain embodiments, the cleanup process (800) may ensure that the replica is consistent with its source data. Additionally, the cleanup process (800) may reduce the overall size of the replica, thereby conserving system resources.

The replica is presented (step 802) to the destination host. The server (112, FIG. 1) then sends (step 804) the destination host information on the files which have been selected for replication. The destination host may remove (step 806) any data in the replica which may be associated with files which have not been selected for replication. For example, one or more blocks may contain data having a mixture of files that are selected for replication and files that are not selected for replication. In a step of reducing (step 808) the amount of space required by the replica may be performed by, for example, de-allocating unused blocks in the replica.

The replication process may be performed at a faster rate while consuming fewer system resources. The input/output demand placed on the source volume is reduced as less data needs to be copied. Storage space is always a limited resource and having smaller replicas reduces the chance that the storage array will reach its full capacity.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method, comprising:
identifying with a server a first range of data blocks in a storage device array corresponding to data files selected for replication, said first range of data blocks being managed by a source host device;
mapping, with at least one of a controller of said storage device array and a destination host device, said first range of data blocks to a second range of data blocks in said storage device array managed by said destination host device;
copying, with said storage device array controller, said data blocks from said first range that contain said data files selected for replication to said corresponding data blocks in said second range; and
deleting, with said storage device array controller, files in said copied data blocks of said second range that have not been selected for replication.

2. The method of claim 1, wherein said data files selected for replication are selected by an administrator through a user interface of said server.

3. The method of claim 1, wherein said data files are selected for replication by at least one of: individual files, directories containing the files, and specific file types.

4. The method of claim 1, further comprising managing with said server a plurality of replication jobs, wherein each said replication job comprises a unique set of selected data files for replication and at least one of an assigned criticality level and a scheduled time interval between recurring replication jobs.

5. The method of claim 1, wherein said copying further comprises maintaining original offset positions of said blocks in said first range between said copied blocks in said second range.

6. The method of claim 1, further comprising condensing, with said storage device array controller, said second range of data blocks wherein said condensing comprises de-allocating blocks which have been allocated to unused blocks in said second range and shrinking a size of said second range by removing unallocated blocks from said range.

7. A system selective replication, the system comprising;
a storage area network configured to communicatively couple a server, a source host device, a destination host device, and a storage device array;
wherein said server is configured to receive from said source host device a first range of data blocks in said storage device array corresponding to data files selected for replication; said first range of data blocks being managed by said source host device; and
wherein a controller of said storage array is configured to:
map each said data block in said first range of data blocks to a corresponding block of a second range of data blocks in said storage device array managed by said destination host device;
copy only said data blocks from said first range of data blocks that contain said data files selected for replication to said corresponding data blocks in said second range of data blocks; and
delete files in said copied data blocks of said second range that have not been selected for replication.

8. The system of claim 7, wherein said server comprises a user interface.

9. The system of claim 8, wherein said data files selected for replication are selected by an administrator through said user interface of said server.

10. The system of claim 7, wherein said data files are selected for replication according to at least one of: individual files, directories containing the files, and specific file types.

11. The system of claim 7, wherein said server is further configured to manage a plurality of replication jobs, wherein each said replication job comprises a unique set of selected data files for replication and at least one of an assigned criticality level and a scheduled time interval between recurring replication jobs.

12. The system of claim 7, wherein said copying further comprises maintaining original offset positions of said blocks in said first range between said copied blocks in said second range.

13. The system of claim 7, wherein said controller of said storage device array is further configured to condense said second range of data blocks by de-allocating blocks which have been allocated to unused blocks in said second range and shrinking a size of said second range by removing unallocated blocks from said range.

14. A computer program product comprising:
a computer readable medium having computer readable code stored thereon, wherein said computer readable code comprises:
computer readable code configured to query a source host device to identify a first range of data blocks in a storage device array corresponding to data files selected for replication, said first range of data blocks being managed by said source host device; and
computer readable code configured to instruct at least one of a controller of said storage device array and a destination host device to:
map said first range of data blocks to a second range of data blocks in said storage device array managed by said destination host device;
copy only said data blocks from said first range that contain said data files selected for replication to said corresponding data blocks in said second range;
delete files in said copied data blocks of said second range that have not been selected for replication; and
condense said second range of data blocks.

15. The computer program product of claim 14, wherein said computer readable code further comprises computer readable code configured to receive at least one instruction through a user interface that identifies said data files selected for replication.

16. The computer program product of claim 14, wherein said computer readable code further comprises computer readable code configured to manage a plurality of replication jobs, wherein each said replication job comprises a unique set of selected data files for replication and at least one of an assigned criticality level and a scheduled time interval between recurring replication jobs.
